(19) United States
(12) Patent Application Publication
(10) Pub. No.: US 2026/0197769 A1
(43) Pub. Date: Jul. 9, 2026

(54) DYNAMIC POWER CLASS SELECTION FOR NON-TERRESTRIAL NETWORKS

(71) Applicant: T-Mobile USA, Inc., Bellevue, WA (US)

(72) Inventor: Akin Ozozlu, McLean, VA (US)

(21) Appl. No.: 19/011,322

(22) Filed: Jan. 6, 2025

(51) Int. Cl. H04W 52/18; H04B 7/185; H04W 52/38

(52) U.S. Cl. CPC H04W 52/18; H04B 7/18513; H04W 52/38

(57) ABSTRACT

Wireless device transmissions to non-terrestrial networks face challenges due to limited link budgets, at least at mid-band Personal Communications Service (PCS) or Advanced Wireless Services (AWS) frequencies. An example solution includes a method that involves causing a wireless device that is classified or capable of a first power class to instead use a second power class (having a lower maximum transmit power) by default while operating in a terrestrial communication mode. Upon a transition from the terrestrial mode to a non-terrestrial mode (e.g., a satellite mode), the wireless device evaluates its connection with a non-terrestrial network with non-terrestrial nodes. If the evaluated connection does not meet certain success thresholds, the wireless device dynamically switches to the first power class to improve its connection to the non-terrestrial network. The flexibility in power class configuration for a wireless device uniquely allows a device to handle communications with terrestrial and non-terrestrial networks.

### BACKGROUND

Non-terrestrial and/or satellite communication systems will become an integral part of global telecommunications infrastructure, providing connectivity in remote and underserved areas where terrestrial networks cannot. These systems would involve transmitting signals between non-terrestrial satellites and ground stations, ideally enabling a wide range of services for those ground stations (e.g., user equipment (UE)) including voice, data, and multimedia communications. Non-terrestrial and/or satellite systems can also address needs for reliable communication in various sectors such as maritime, aviation, and emergency response. For these uses of non-terrestrial systems to be realized, signals need to be reliably received at both satellites and UEs, which can be located hundreds of kilometers apart.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates core network functions (NFs) that can implement aspects of the present technology.

FIG. 3 is a flow diagram of a method for improving uplink transmissions from ground stations to non-terrestrial networks, according to example implementations disclosed herein.

FIG. 4 illustrates a system enabling reference signal boosting for improving downlink transmissions between non-terrestrial networks and ground stations, according to example implementations disclosed herein.

FIGS. 5A and 5B are flow diagrams of methods for improving downlink transmissions between non-terrestrial networks and ground stations, according to example implementations disclosed herein.

FIG. 6 is a block diagram that illustrates an example implementation of a prediction model used for dynamically boosting downlink reference signals to improve downlink transmissions between non-terrestrial networks and ground stations, according to example implementations disclosed herein.

FIGS. 7A and 7B illustrate example bandwidth reservation/allocation mechanisms for satellite beam cells of a non-terrestrial network.

FIGS. 8A and 8B are flow diagrams of method for intelligently configuring spectrum bandwidth for satellite beam cells of a non-terrestrial network.

FIG. 9 is a block diagram that illustrates an example of a computing system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present disclosure introduces solutions for dynamically and selectively changing power class configurations of UEs based on the UE's device state and current connection characteristics. In cellular network specifications, maximum output power levels are categorized into different power classes to support various use cases and device types. Setting appropriate power classes is an important part of configuring both user equipment (UE) and base stations to ensure adequate coverage and quality of service while minimizing interference. By defining the transmission power levels of devices and base stations, power level classifications help in optimizing network performance, managing interference, and ensuring efficient energy usage. Different power classes are designated for various types of devices, from high-power base stations to low-power Internet of Things (IoT) devices.

Wireless device transmissions to non-terrestrial networks, such as Low Earth Orbit (LEO) satellite systems, face significant challenges due to limited link budgets, particularly at mid-band Personal Communications Service (PCS) or Advanced Wireless Services (AWS) frequencies. These frequencies, around 2 GHz, struggle to maintain reliable communication over the vast distances to space, typically around 300-360 km from the user equipment (UE). Although Power Class 2(PC2 ) devices have emerged, the higher transmit power that these devices are capable of is constrained by the dense deployment of terrestrial networks and the need to conserve battery life.

To address these challenges, the disclosed solutions involve a UE being configured to use a lower power class (e.g., a PC2 device operating under Power Class 3 (PC3)) in default terrestrial scenarios and then using a higher power class (e.g., the PC2 device changing from PC3 operation to PC2 operation), after transitioning to non-terrestrial communications and if the non-terrestrial communications require the higher power class to meet success requirements. This dynamic adjustment ensures that the UE can maintain robust communication links without unnecessarily draining its battery during terrestrial operations, and only resort to using its maximum transmit capabilities when necessary.

These disclosed implementations involving flexible power class configurations are uniquely suited for operation in networks configured for frequency division duplex (FDD) bidirectional (uplink/downlink) communication, or networks with duplexing techniques that increase the proportion of uplink transmissions relative to time division duplex (TDD) techniques. Specifically, non-TDD techniques may involve uplink transmissions during 100% of a frame or sub-frame, while TDD techniques may only involve uplink transmissions during 20% of a (sub)frame. Thus, while TDD techniques may allow for continuous use of high transmit power, liberal use of high transmit power in non-TDD settings would result in high power drain and other undesirable effects (e.g., temperature increases, hardware wear). The disclosed implementations enable situational use and planning on high transmit power, and thus allow networks to continue the implementation of non-TDD techniques.

The present disclosure also introduces solutions that enhance downlink connection reliability in non-terrestrial wireless networks by leveraging predictive modeling and historical data to dynamically adjust reference signal power. These solutions address the technical problems associated with maintaining consistent and reliable downlink communication in Low Earth Orbit (LEO) satellite systems, in view of the distances between satellite and UE.

In particular, LEO satellite systems, which are becoming popular for rural coverage and may further expand to support (dense) urban areas, are generally located at approximately 300 to 400 kilometers above the ground. In existing non-terrestrial and satellite systems (which operate at the 1.9 to 2.1 GHz spectrum bands), wireless devices (e.g., UEs) typically measure RSRP (received signal reference power) in the range of −100 dBm to −130 dBm constantly. These signal levels in existing systems are too weak to have reasonable downlink connection quality, and instead cause service disruptions and user dissatisfaction.

Solutions to these challenges must further consider the trade-offs between extending reference signal power versus capacity loss. In 4G Long-Term Evolution (LTE) and 5G New Radio (NR) systems, cell-specific reference signal (CRS) boost and synchronization signal block (SSB) boost (respectively) often causes some traffic channel (e.g., physical downlink shared channel (PDSCH)) physical resource block (PRB) shutdown. In particular, reference signal boost mechanisms function by diverting transmission resources away from traffic channels to control/pilot channels instead, for the transmission of the reference signals with more power. That is, given a finite amount of transmission resources, reference signals cannot be simply boosted without negatively affecting traffic channels.

Solutions disclosed herein address at least these technical challenges by selectively and optionally activating reference signal power boosting on a per-cell basis according to predictions of downlink received signal strengths. By storing and analyzing Key Performance Indicator (KPI) data, such as Reference Signal Received Power (RSRP) from previous satellite passes, the system predicts expected RSRP for following satellite fly-bys for an area. This predictive capability enables targeted reference signal power boosting where the impacts on traffic channel transmission are acceptable, thereby improving signal quality and reducing service disruptions overall.

The present disclosure further introduces solutions that enhance spectrum allocation in non-terrestrial wireless networks. Another significant challenge faced by mobile satellite systems is the efficient management of the radio frequency spectrum. The spectrum is a finite resource that must be shared among multiple users, including terrestrial networks and other satellite systems. This sharing is further complicated by the need to manage interference between beams of the same satellite, especially as the number of beams per satellite increases. Modern satellites can have hundreds of beams, each requiring careful spectrum allocation to maximize service quality and coverage. As the number of beams per satellite increases, certain re-use techniques that simply allocate a static and small portion of bandwidth to each satellite become inadequate. These methods restrict the full utilization of available spectrum bandwidth for the sake of minimizing interference between closely grouped beams, thus limiting the range and quality of services that can be provided.

Example solutions disclosed herein address the challenges related to managing limited spectrum resources while minimizing interference and maximizing service quality in satellite communication systems, especially between multiple beam cells projected or deployed from a single non-terrestrial satellite. The example solutions disclosed herein involve prediction of traffic loads for each beam cell within a geographic area before the non-terrestrial satellite deploys beam cells within the geographic area. These predictions are based on historical network traffic data collected from previous satellite flybys and generated using a trained model. Based on these predictions, spectrum bandwidths are allocated or assigned to the beam cells: high-load beam cells can be assigned larger, static spectrum bandwidths, while other beam cells can receive smaller, dynamic spectrum bandwidths that change frequencies according to a predefined hopping sequence. The disclosed approaches can thereby optimize bandwidth utilization, reduce interference, and enhance overall service quality and coverage in satellite communication systems.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Example Embodiments of Wireless Communications Systems

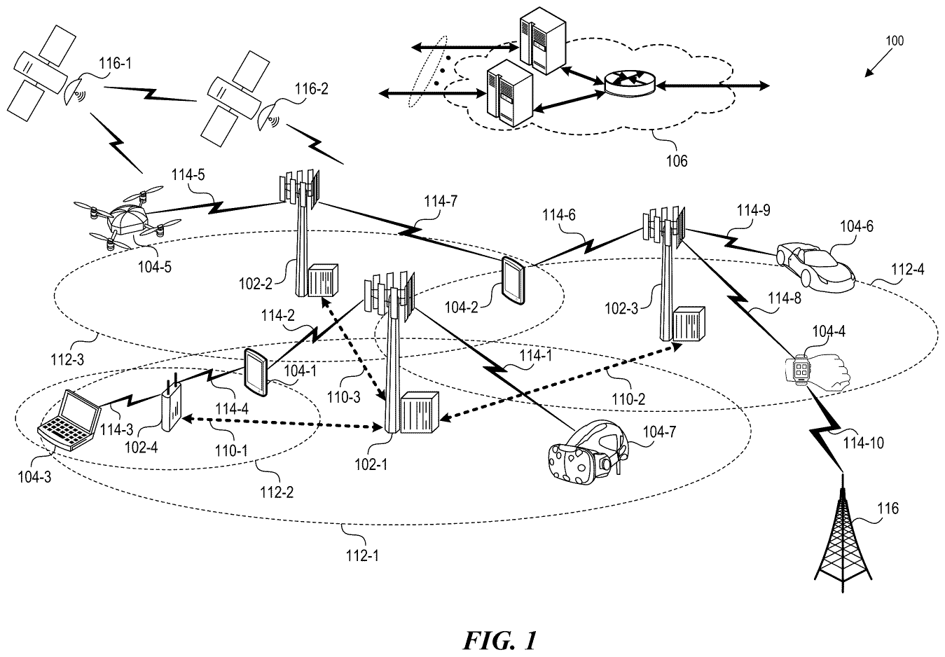

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### Example Embodiments of Core Network Functions

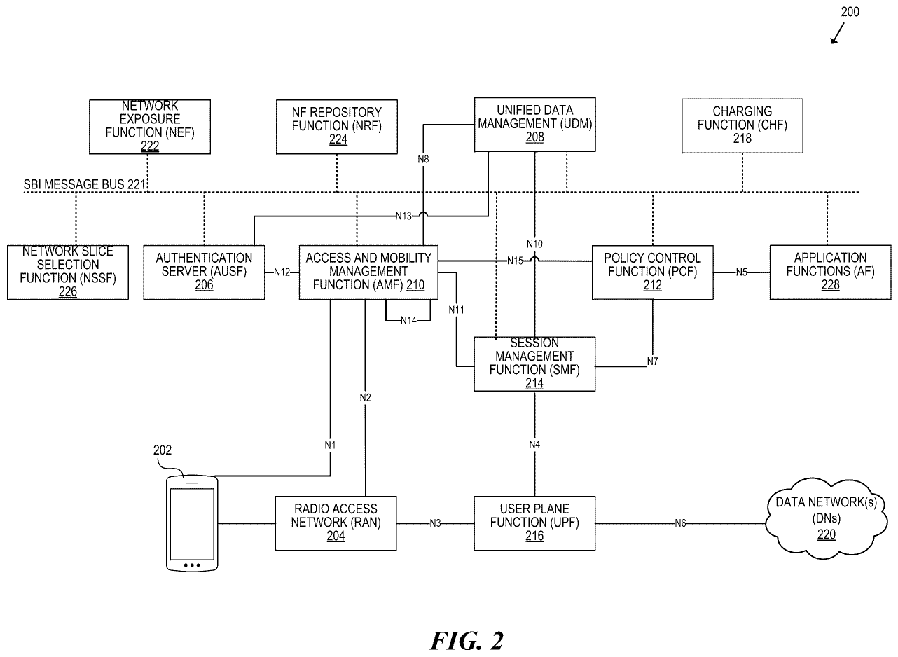

FIG. 2 is a block diagram that illustrates an architecture 200 including core network functions (NFs) that can implement aspects of the present technology. While certain examples disclosed herein may refer to 5G core network functions, it will be understood that the various solutions disclosed herein may be implemented using core network functions of other (or similar) systems, such as a 6G system.

A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Example Techniques for Ue Power Class Configuration for Non-terrestrial Operation

As discussed above, technical challenges related to connectivity between ground stations and non-terrestrial satellites can be addressed through improving uplink transmissions by a ground station. In particular, solutions disclosed herein provide for dynamic power class configurations for UEs for non-terrestrial communication.

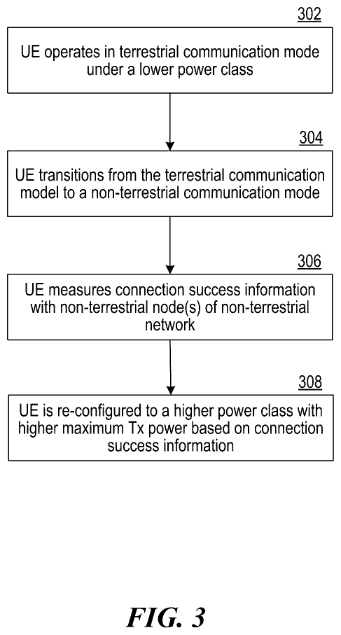

FIG. 3 is a flow diagram with example operations for a UE dynamically selecting power class configurations for use with non-terrestrial networks. The UE may implement the example operations for the technical benefits disclosed herein, for example, to realize power saving benefits and adaptability between terrestrial and non-terrestrial networks. Depending on the implementation, the UE may be a personal device such as a smartphone, tablet, laptop, or the like, or a non-user device such as an Internet-of-Things (IoT) device. The UE is a wireless device configured to connect to both terrestrial networks and non-terrestrial networks.

At 302, the UE operates in a terrestrial communication mode under a lower power class. In some implementations, the terrestrial communication mode is a default operating mode, which may be configured to use the lower power class. In the terrestrial communication mode, the UE may be configured to only connect to terrestrial networks, or to not connect to non-terrestrial networks. While the UE is operating in the terrestrial communication mode, the UE might not be connected to any (terrestrial) network but does not attempt connection to a non-terrestrial network.

The lower power class is a power class with a maximum transmit power less than the highest power class that the UE is capable of. For example, the UE may be classified or rated as a Power Class 2(PC2 ) device based on its hardware capabilities allowing a maximum transmit power of 26 decibel-milliwatts (dBm). In this example, the lower power class may be Power Class 3(PC3 ), which has a maximum transmit power of 23 dBm, or another power class with a maximum transmit power less than 26 dBm. In some implementations, the particular power class that is lower than the highest capable power class may be selected according to other conditions such as battery usage, network frequency band, and/or the like.

In some implementations, the power classes that the UE may operate according to and by which the UE may be classified are defined according to technical specifications, such as those maintained by original equipment manufacturers (OEMs) or industry organizations. For example, the power classes may be defined by the technical specifications provided by the Third Generation Partnership Project (3GPP) (e.g., TS 38.101).

At 304, the UE transitions from the terrestrial communication mode to a non-terrestrial communication mode. In the transition, the UE may at least initially maintain operation under the lower power class. For example, the non-terrestrial communication mode is configured to initially continue use of the lower power class, or continue use of the same power class used by the terrestrial communication mode. Thus, the transition to the non-terrestrial communication mode does not automatically increase the UE's operating power class.

The non-terrestrial communication mode is a mode in which the UE is permitted to connect to non-terrestrial networks. In some implementations, the transition to the non-terrestrial communication mode causes the UE to begin searching for or establishing connections with non-terrestrial nodes of a non-terrestrial network.

In some implementations, the transition to the non-terrestrial communication mode may be a result of a user input. For example, a user or operator of the UE may manually switch the UE to a “satellite mode.” In other implementations, the UE may receive a control signalling, a command, an instruction, and/or the like from a remote system that causes the UE to transition to the non-terrestrial communication mode. For example, the UE may receive a transmission that includes a public land mobile network (PLMN) identifier or a physical cell ID (PCI) that is associated with a non-terrestrial network, and the UE transitions to the non-terrestrial mode in response.

In some implementations, the transition to the non-terrestrial communication mode is an automatic response to a disconnect condition related to the UE's connection to a terrestrial network. In one example of a disconnect condition, the UE moves to a location that is located outside of mapped coverage areas for a terrestrial network. In another example of a disconnect condition, a connection status or quality between the UE and the terrestrial network deteriorates below a predefined threshold.

At 306, the UE measures connection success information with one or more non-terrestrial nodes of the non-terrestrial network that it connects to (or attempts to connect to) while in the non-terrestrial communication mode. The non-terrestrial network may be configured for FDD or non-TDD bidirectional communication, thus requiring a higher proportion (per frame/subframe) of uplink transmission. The UE measures the connection success information so that it can determine whether it should increase its operating power class. Accordingly, the UE may measure the connection success information if increasing its operating power class is permitted. Increasing its operating power class may not be permitted or necessary if the non-terrestrial network is configured for TDD bidirectional communication.

In some implementations, the UE may measure the connection success information if one or more radio frequency (RF) safety conditions are met, allowing for a higher power class to be used. Increased transmit power under higher power classes may be associated with higher specific absorption rates (SARs), and the one or more RF safety conditions may include a maximum SAR limit to prevent harm to a user's body. SAR may be critical when the UE is positioned close to the user's body, such as to the user's head. SAR limits or requirements may be relaxed if the UE is being held in a user's hand away from the user's head.

Thus, the UE may measure the connection success information if the UE is not positioned near the user's head and increasing power class is thereby permitted with regard to SAR. The UE may determine that it is likely not positioned near a user's head based on a type of user service being currently performed on the UE. For example, use of a SMS/MMS application, an Internet browsing application, and/or the like is typically done while the UE is being held in the user's hand away from the user's head. In some implementations, the UE may determine that it is likely not positioned near the user's head based on sensor data generated by sensors onboard the UE. For example, the UE may include infrared (IR) sensors, accelerometers, gyroscopes, and/or the like that can generate data indicating whether the UE is being raised up to the user's head. In some implementations, the UE determines that it is likely not positioned near the user's head based on its device type. For example, an IoT device or another non-personal device (e.g., an in-vehicle device or system) may not be a handheld device that is typically brought close to a user's head.

The connection success information describes a status or quality of the UE's connection with the non-terrestrial nodes of the non-terrestrial network, and can thus suggest whether an increased transmit power under a higher power class would improve the UE's connection with the non-terrestrial network. In some implementations, the connection success information includes a success rate of random access channel (RACH) attempts to the non-terrestrial network. In some implementations, the connection success information includes higher layer service or non-access stratum (NAS) signaling success rates (e.g., ATTACH success rates), SMS/MMS delivery rates, packet loss rates, number of disconnections, and/or the like.

At 308, the UE is re-configured to use a higher power class based on the connection success information. For example, the UE re-configures the non-terrestrial communication mode to use the higher power class. In a non-limiting illustrative example, the UE may have been operating under PC3 with a maximum transmit power of 23 dBm, and switches to operation under PC2 with a maximum transmit power of 26 dBm. Again, the UE may use the higher power class if the RF safety conditions are met.

The UE may switch to the higher power class if the connection success information fails to satisfy one or more pre-defined thresholds. For example, if the RACH success rate measured in the connection success information is below 75%, then the UE switches to the higher power class.

In some implementations, the re-configuration of the UE to use the higher power class includes the UE reporting the higher power class and/or the connection success information to the non-terrestrial network and/or the non-terrestrial nodes. For example, the UE may report the connection success information to the non-terrestrial nodes, which then send control signaling to the UE to cause the UE to use the higher power class.

The re-configuration to use the higher power class may be effective for a duration while the UE is operating in the non-terrestrial communication mode. In some examples, the UE continues to use the higher power class until it returns to the terrestrial communication mode (e.g., based on user input, based on a received signal, based on re-established connection to a terrestrial network). In some examples, the duration that the UE uses the higher power class is predicted or determined based on input features such as UE location or proximity to a terrestrial network cell, coverage of the non-terrestrial nodes, type of application (e.g., a brief need for network connection to send one SMS message or a longer need for network connection to stream a video), and/or the like. Subsequent to the duration, the UE may return to the lower power class. For example, the UE further re-configures the non-terrestrial communication mode of the UE to use a lower power class (which may be the same as the original lower power class, or may be another power class lower than the higher power class). In some implementations, the UE may measure again the connection success information, and if the RACH success rate for example is above a nominal threshold, then the UE may decrease to the lower power class. In some implementations, the UE may cease to use the higher power class based on a battery condition (e.g., a battery level threshold), thus conserving its power supply.

In some implementations, the UE may broadcast or report its re-configuration to use the higher power class to other UEs located nearby. The broadcasting or reporting may be done via a local network or local communications, such as Bluetooth or Wi-Fi connections. In an example scenario, a group of people each having UEs are camping in the wilderness, and one person's UE that is re-configured to use the higher power class may report it doing so to the other people's UEs so that those UEs can reduce some processing in determining whether to respectively adjust their power classes. In particular, the UE broadcasting or reporting its re-configuration can indicate to other nearby UEs that those UEs should switch to a non-terrestrial communication mode, due to the UE's failure to at least establish a connection with a terrestrial network. That is, a given UE may transition to the non-terrestrial communication mode based on nearby UEs also transitioning to the non-terrestrial communication mode and/or the nearby UEs dynamically increasing their power class. In some implementations, the nearby UEs may transition to the non-terrestrial communication and begin searching for connection to the non-terrestrial network, but may individually measure connection success information and determine whether to increase their own respective power classes. Thus, the power class operation of each UE remains dynamic and individualized.

### Example Techniques for Dynamic Downlink Reference Signal Boosting

As discussed above, technical challenges related to connectivity between ground stations and non-terrestrial satellites can be addressed (in addition or alternative to other solutions disclosed herein) through improving downlink signalling by a non-terrestrial satellite. In particular, solutions disclosed herein provide for dynamic downlink reference signal boosting by non-terrestrial satellites for upcoming fly-bys.

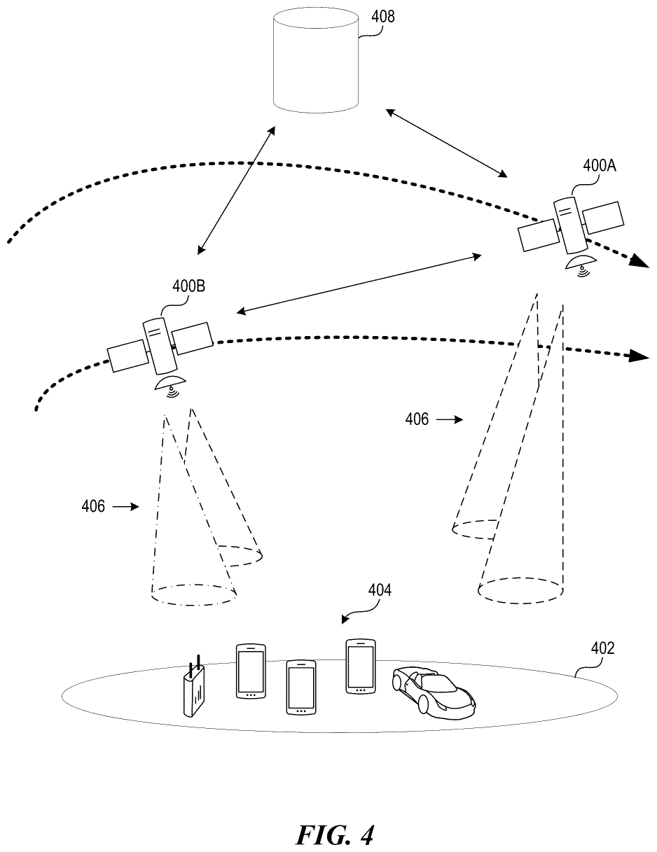

FIG. 4 illustrates a system for reference signal boosting throughout a constellation of non-terrestrial satellites. The system includes a constellation of non-terrestrial satellites, or a plurality of non-terrestrial satellites that are communicably coupled to one another and/or to a central station (not illustrated). In the illustrated example, for example, the constellation of non-terrestrial satellites includes a first satellite 400A and a second satellite 400B. The central station may be one or more particular non-terrestrial satellites among the constellation (e.g., one or more of the first satellite 400A or the second satellite 400B) and/or a ground or terrestrial-based control station. The constellation of non-terrestrial satellites can communicate control data with the central station; for example, the central station can provide instructions for navigation, beam cell deployment, collision avoidance, and/or other functionalities for the satellites.

The non-terrestrial satellites are configured to provide radio access functionality for a telecommunication network to wireless devices (e.g., UEs) on the ground. Particularly, the non-terrestrial satellites are configured to deploy beam cells via which wireless devices can connect to a telecommunications network. The illustrated example includes a geographic area 402 within which the constellation of non-terrestrial satellites can deploy beam cells 406 to serve the wireless devices 404 located within the geographic area 402. At a given time, according to the planned routes and trajectories of the constellation of non-terrestrial satellites, one or more satellites may be deploying beam cells 406 within the geographic area 402. Each satellite may be configured to deploy hundreds of beam cells, for example, between 200 and 512 beams.

To attach or connect to a beam, a wireless device 404 may need to reliably receive downlink reference signals transmitted from a non-terrestrial satellite, such as cell-specific reference signals (CRSs) in 4G LTE systems and synchronization signal blocks (SSBs) in 5G NR systems. According to the solutions disclosed herein, those downlink reference signals may be dynamically (e.g., selectively, optionally) boosted with respect to transmission power so that the wireless device 404 can detect and use the downlink reference signals.

In particular, the system depicted in FIG. 4 enables a constellation of satellites to aggregate signal strength information for the geographic area 402 during each fly-by, and the aggregated/collected information can be used to determine, for the next fly-by by any one of the constellation of satellites, whether to perform reference signal boosting. As illustrated, the system can include a database 408 to which the constellation of non-terrestrial satellites (and/or a central station for the constellation) is communicably coupled. The database 408 can be non-terrestrial (e.g., implemented onboard one or more satellites) or terrestrial. The database 408 can store information enabling predictions of signal strengths of downlink reference signals in the geographic area 402, such as network access information and/or signal strength information.

In an illustrative example, the first satellite 400A may perform a first fly-by over the geographic area 402 to deploy a first set of beam cells 406. In its deployment of the first set of beam cells, the first satellite 400A receives signal strength information measured by the wireless devices 404 that attach or connect to the first set of beam cells 406. For example, each wireless device 404 measures a reference signal received power (RSRP) information during its attachment and connection to one or more of the first set of beam cells 406, and reports the RSRP information to the first satellite 400A. Accordingly, the first satellite 400A can determine a signal strength information for each of the first set of beam cells 406, including an average RSRP per cell.

During or subsequent to its fly-by over the geographic area 402, the first satellite 400A can provide network access information, including the signal strength information, to the database 408. In some implementations, the first satellite 400A can provide the network access information to a central station (e.g., another satellite, a ground control station) that stores the network access information in the database 408. The database 408 can store the network access information provided by the first satellite 400A in association with the geographic area 402. The network access information associated with the geographic area 402 can be periodically updated within the database 408 with each fly-by of a satellite over the geographic area 402.

For the geographic area 402, the network access information stored by the database 408 can include the signal strength information (e.g., average RSRP per beam cell) and can further include signal quality information (e.g., reference signal received quality (RSRQ) information, signal-to-interference ratio (SINR) information, and/or the like), traffic volume information (e.g., average/total random access channel (RACH) attempt counts), error information (e.g., packet error rate, block error rate (BLER), hybrid automatic repeat request (HARQ) performance, number of radio link control (RLC) fails), and/or the like. The database 408 can further store satellite trajectory or route information associated with the first satellite's fly-by over the geographic area 402.

The network access information for the geographic area 402 stored in the database 408 may be defined on a per-cell basis, according to the first set of beam cells deployed by the first satellite 400A. In some implementations, the network access information may be or include a map of the geographic area 402; for example, the network access information includes a RSRP map of the geographic area 402.

A second satellite 400B may be traveling along a trajectory or route along which the second satellite 400B is scheduled or expected to deploy a second set of beam cells 406 within the geographic area 402 on its fly-by. The second satellite 400B may be following the first satellite 400A along a same trajectory or route, or may be navigated along its own route which also includes a fly-by for the geographic area 402.

Before its fly-by over the geographic area 402, the second satellite 400B can determine whether to perform a reference signal boosting for any of its second set of beam cells 406 based on the information stored in the database 408. The second satellite 400B can pull information from the database 408 for the determination, or the second satellite 400B can receive the determination from a central station that is configured to process the information stored within the database 408.

The determination of whether to perform a reference signal boosting for any of the second set of beam cells 406 is predictive. Specifically, a prediction model is configured and/or pre-trained based on information stored in the database 408 to predict at least an expected signal strength information (e.g., average RSRP per beam). In some implementations, the prediction model is machine learning model that is trained (pre-trained) (e.g., using linear regression techniques, using supervised/unsupervised/semi-supervised learning techniques) to learn and use relationships between the information stored in the database 408 to predict the expected signal strength information for an upcoming fly-by or for an upcoming time period generally.

The expected signal strength information can then be used to determine whether any of the second set of beam cells 406 should be deployed with reference signal boosting. In some implementations, if the expected average RSRP for a given beam satisfies a predetermined signal strength threshold (e.g., less than −100 dBm, less than −130 dBm), then the given beam may be selected for reference signal boosting. Due to the per-cell specificity of the information stored in the database 408, the predictions of expected signal strength information and determinations of reference signal boosting can also be cell-specific. Thus, in some examples, a subset of the second set of beam cells 406 may be deployed with reference signal boosting, while remaining ones of the second set of beam cells 406 may be deployed without reference signal boosting.

Generally, reference signal boosting may be configured based on additional expected or predicted factors other than the expected signal strength (e.g., expected RSRP), such as packet/block error rate. In some implementations, a trajectory of the second satellite 400B, and an elevation angle of the second satellite 400B relative to the geographic area, can be additionally considered for whether the second satellite 400B will generally perform reference signal boosting. For example, the second satellite 400B having a lower elevation angle relative to the geographic area may result in a greater distance between the second satellite 400B and the wireless devices 404, suggesting a need for reference signal boosting.

In some implementations, expected/predicted traffic volume within the geographic area can also be considered when determining whether to perform reference signal boosting. As discussed, reference signal boosting negatively impacts transmission of traffic channels. Accordingly, a high traffic volume within the geographic area 402 (or a portion thereof for a beam cell) decreases a need or desirability of reference signal boosting, as the capacity loss for the traffic channels that would result from the reference signal boosting likely would lead to service loss for the high traffic volume.

The second satellite 400B can therefore be prepared to deploy at least some of the second set of beam cells 406 with reference signal boosting when it performs its fly-by. As with the first satellite 400A, the second satellite 400B can collect actual network access information and/or signal strength information during its deployment and provide that collected information to the database 408, to assist subsequent satellites in their fly-bys over the geographic area 402.

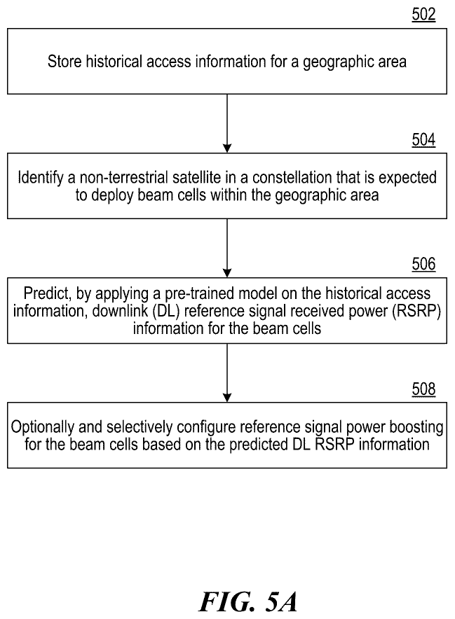

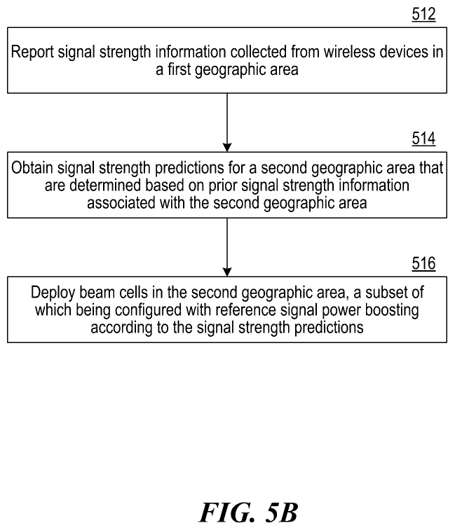

FIG. 5A is a flow diagram of a method for predictive boosting of downlink reference signals transmitted from non-terrestrial satellites. The method includes example operations that can be performed by a computing system, for example by at least one processor thereof executing instructions stored in at least one memory of the computing system. In some implementations, the computing system is a ground-based system, such as a ground control station (GCS) for one or more non-terrestrial satellites. In some implementations, the computing system is a non-terrestrial system, such as one particular satellite or a group of satellites sharing computing/processing and storage functions. In some implementations, the computing system is an embodiment of one or more core network functions of a telecommunications network with which the non-terrestrial satellites are associated.

At 502, the system stores historical network access information for a geographic area. The historical network access information can be stored at a database that may be implemented at a cloud platform, a distributed platform, one or more ground stations, one or more non-terrestrial satellites, one or more core network functions, and/or the like. The historical network access information is collected by each satellite deploying beam cells within a geographic area during their fly-bys. For example, the historical network access information includes signal strength information measured by wireless devices for the beam cells deployed by satellites. In some implementations, the historical network access information includes terrestrial-based information, or information collected in the course of the deployment of terrestrial network cells.

At 504, the system identifies a non-terrestrial satellite in a constellation that is expected to deploy beam cells within the geographic area. The system can identify the non-terrestrial satellite based on a planned trajectory or route for the satellite. In some implementations, the system can determine a sequence or schedule of specific satellites that will provide coverage for a given geographic area.

At 506, the system predicts signal strength information for the beam cells to be deployed by the non-terrestrial satellite within the geographic area. The signal strength information being predicted can include downlink RSRP information expected to be measured by wireless devices being served by the beam cells. The system can predict the signal strength information by applying a prediction model that is configured and/or pre-trained on the historical network access information. In some implementations, the system can train the model using the historical network access information to predict the signal strength information based at least on other features included in network access information generally. For example, the model is a linear regression machine learning model.

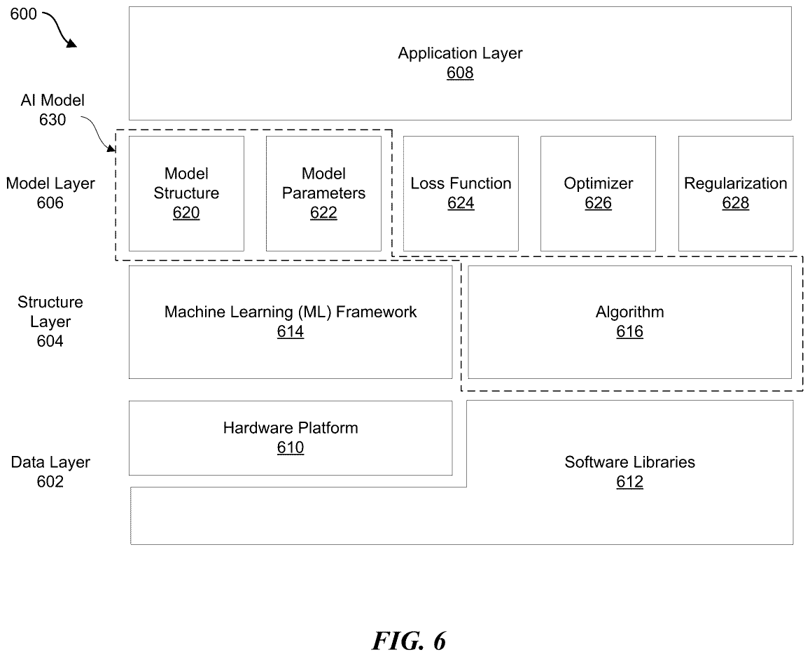

FIG. 6 illustrates an example artificial intelligence (AI) and/or machine learning (ML) system 600 that can implement a prediction model for predicting signal strength information for upcoming deployments of beam cells. As shown, the AI system 600 can include a set of layers, which conceptually organize elements within an example network topology for the AI system's architecture to implement a particular AI model 630. Generally, an AI model 630 is a computer-executable program implemented by the AI system 600 that analyses data to make predictions. Information can pass through each layer of the AI system 600 to generate outputs for the AI model 630. The layers can include a data layer 602, a structure layer 604, a model layer 606, and an application layer 608. The algorithm 616 of the structure layer 604 and the model structure 620 and model parameters 622 of the model layer 606 together form the example AI model 630. The optimizer 626, loss function engine 624, and regularization engine 628 work to refine and optimize the AI model 630, and the data layer 602 provides resources and support for application of the AI model 630 by the application layer 608.

The data layer 602 acts as the foundation of the AI system 600 by preparing data for the AI model 630. As shown, the data layer 602 can include two sub-layers: a hardware platform 610 and one or more software libraries 612. The hardware platform 610 can be designed to perform operations for the AI model 630 and include computing resources for storage, memory, logic and networking. These computing resources can be terrestrially-based and/or non-terrestrially-based and can be distributed across multiple individual devices (e.g., multiple satellites, multiple servers). The hardware platform 610 can process amounts of data using one or more servers. The servers can perform backend operations such as matrix calculations, parallel calculations, machine learning (ML) training, and the like. Examples of servers used by the hardware platform 610 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 610 can include Infrastructure as a Service (IaaS) resources, which are computing resources, (e.g., servers, memory, etc.) offered by a cloud services provider. The hardware platform 610 can also include computer memory for storing data about the AI model 630, application of the AI model 630, and training data for the AI model 630. The computer memory can be a form of random-access memory (RAM), such as dynamic RAM, static RAM, and non-volatile RAM.

The software libraries 612 can be thought of as suites of data and programming code, including executables, used to control the computing resources of the hardware platform 610. The programming code can include low-level primitives (e.g., fundamental language elements) that form the foundation of one or more low-level programming languages, such that servers of the hardware platform 610 can use the low-level primitives to carry out specific operations. The low-level programming languages do not require much, if any, abstraction from a computing resource's instruction set architecture, allowing them to run quickly with a small memory footprint. Examples of software libraries 612 that can be included in the AI system 600 include Intel Math Kernel Library, Nvidia cuDNN, Eigen, and Open BLAS.

The structure layer 604 can include an ML framework 614 and an algorithm 616. The ML framework 614 can be thought of as an interface, library, or tool that allows users to build and deploy the AI model 630. The ML framework 614 can include an open-source library, an application programming interface (API), a gradient-boosting library, an ensemble method, and/or a deep learning toolkit that work with the layers of the AI system facilitate development of the AI model 630. For example, the ML framework 614 can distribute processes for application or training of the AI model 630 across multiple resources in the hardware platform 610. The ML framework 614 can also include a set of pre-built components that have the functionality to implement and train the AI model 630 and allow users to use pre-built functions and classes to construct and train the AI model 630. Thus, the ML framework 614 can be used to facilitate data engineering, development, hyperparameter tuning, testing, and training for the AI model 630. Examples of ML frameworks 614 that can be used in the AI system 600 include TensorFlow, PyTorch, Scikit-Learn, Keras, Cafffe, LightGBM, Random Forest, and Amazon Web Services.

The algorithm 616 can be an organized set of computer-executable operations used to generate output data from a set of input data and can be described using pseudocode. For example, the algorithm 616 can be used to generate output data that is a binary indication of whether power boosting should be activated for each beam cell, or output data that quantitatively predicts a signal strength information (e.g., RSRP) for each beam cell, and/or the like. The algorithm 616 can include complex code that allows the computing resources to learn from new input data and create new/modified outputs based on what was learned. The input data can describe contexts or factors surrounding previous instances in which the outcomes that the algorithm is configured to predict occurred. For example, the input data from which the AI model can learn from in order to quantitatively predict signal strength information for an upcoming beam cell deployment can include environmental factors, distance between satellite and UE, UE traffic within the beam cell, beam cell configuration (e.g., number of antennas, coverage area), UE device types, and/or the like. In some implementations, the algorithm 616 can build the AI model 630 through being trained while running computing resources of the hardware platform 610. This training allows the algorithm 616 to make predictions or decisions without being explicitly programmed to do so. Once trained, the algorithm 616 can run at the computing resources as part of the AI model 630 to make predictions or decisions, improve computing resource performance, or perform tasks. The algorithm 616 can be trained using supervised learning, unsupervised learning, semi-supervised learning, and/or reinforcement learning.

Using supervised learning, the algorithm 616 can be trained to learn patterns (e.g., map input data to output data) based on labeled training data. The training data may be labeled by an external user or operator. For instance, a user may collect a set of training data, from sets of historical data. In an example implementation, training data can include historical signal strength information, or can include factors and contexts associated with historical reference signals that were sufficiently (e.g., according to one or more thresholds) strong or weak such as traffic volume, satellite positioning, time, and/or the like. The user may label the training data based on one or more classes (e.g., whether or not reference signal boosting was performed or should have been performed) and trains the AI model 630 by inputting the training data to the algorithm 616. The algorithm determines how to label the new data based on the labeled training data. The user can facilitate collection, labeling, and/or input via the ML framework 614. In some instances, the user may convert the training data to a set of feature vectors for input to the algorithm 616. Once trained, the user can test the algorithm 616 on new data to determine if the algorithm 616 is predicting accurate labels for the new data. For example, the user can use cross-validation methods to test the accuracy of the algorithm 616 and retrain the algorithm 616 on new training data if the results of the cross-validation are below an accuracy threshold.

Supervised learning can involve classification and/or regression. Classification techniques involve teaching the algorithm 616 to identify a category of new observations based on training data and are used when input data for the algorithm 616 is discrete. Said differently, when learning through classification techniques, the algorithm 616 receives training data labeled with categories (e.g., classes) and determines how features observed in the training data. Once trained, the algorithm 616 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 616 is continuous. Regression techniques can be used to train the algorithm 616 to predict or forecast relationships between variables. To train the algorithm 616 using regression techniques, a user can select a regression method for estimating the parameters of the model. The user collects and labels training data that is input to the algorithm 616 such that the algorithm 616 is trained to understand the relationship between data features and the dependent variable(s) (e.g., average signal strength for reference signals in a beam cell). Once trained, the algorithm 616 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill-in missing data for machine-learning based pre-processing operations.

Under unsupervised learning, the algorithm 616 learns patterns from unlabeled training data. In particular, the algorithm 616 is trained to learn hidden patterns and insights of input data, which can be used for data exploration or for generating new data. Here, the algorithm 616 does not have a predefined output, unlike the labels output when the algorithm 616 is trained using supervised learning. Said another way, unsupervised learning is used to train the algorithm 616 to find an underlying structure of a set of data, group the data according to similarities, and represent that set of data in a compressed format.

A few techniques can be used in supervised learning: clustering, anomaly detection, and techniques for learning latent variable models. Clustering techniques involve grouping data into different clusters that include similar data, such that other clusters contain dissimilar data. For example, during clustering, data with possible similarities remain in a group that has less or no similarities to another group. Examples of clustering techniques density-based methods, hierarchical based methods, partitioning methods, and grid-based methods. In one example, the algorithm 616 may be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 616 may be trained to be an Isolation Forest, local outlier factor (LOF) algorithm, or K-nearest neighbor (k-NN) algorithm. Latent variable techniques involve relating observable variables to a set of latent variables. These techniques assume that the observable variables are the result of an individual's position on the latent variables and that the observable variables have nothing in common after controlling for the latent variables. Examples of latent variable techniques that may be used by the algorithm 616 include factor analysis, item response theory, latent profile analysis, and latent class analysis.

The model structure 620 describes the architecture of the AI model 630 of the AI system 600. The model structure 620 defines the complexity of the pattern/relationship that the AI model 630 expresses. Examples of structures that can be used as the model structure 620 include decision trees, support vector machines, regression analyses, Bayesian networks, Gaussian processes, genetic algorithms, and artificial neural networks (or, simply, neural networks). The model structure 620 can include a number of structure layers, a number of nodes (or neurons) at each structure layer, and activation functions of each node. Each node's activation function defines how to node converts data received to data output. The structure layers may include an input layer of nodes that receive input data, an output layer of nodes that produce output data. The model structure 620 may include one or more hidden layers of nodes between the input and output layers. The model structure 620 can be an Artificial Neural Network (or, simply, neural network) that connects the nodes in the structured layers such that the nodes are interconnected. Examples of neural networks include Feedforward Neural Networks, convolutional neural networks (CNNs), Recurrent Neural Networks (RNNs), Autoencoder, and Generative Adversarial Networks (GANs).

The model parameters 622 represent the relationships learned during training and can be used to make predictions and decisions based on input data. The model parameters 622 can weight and bias the nodes and connections of the model structure 620. For instance, when the model structure 620 is a neural network, the model parameters 622 can weight and bias the nodes in each layer of the neural networks, such that the weights determine the strength of the nodes and the biases determine the thresholds for the activation functions of each node. The model parameters 622, in conjunction with the activation functions of the nodes, determine how input data is transformed into desired outputs. The model parameters 622 can be determined and/or altered during training of the algorithm 616.

The loss function engine 624 can determine a loss function, which is a metric used to evaluate the AI model's 630 performance during training. For instance, the loss function engine 624 can measure the difference between a predicted output of the AI model 630 and the actual output of the AI model 630 and is used to guide optimization of the AI model 630 during training to minimize the loss function. The loss function may be presented via the ML framework 614, such that a user can determine whether to retrain or otherwise alter the algorithm 616 if the loss function is over a threshold. In some instances, the algorithm 616 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 626 adjusts the model parameters 622 to minimize the loss function during training of the algorithm 616. In other words, the optimizer 626 uses the loss function generated by the loss function engine 624 as a guide to determine what model parameters lead to the most accurate AI model 630. Examples of optimizers include Gradient Descent (GD), Adaptive Gradient Algorithm (AdaGrad), Adaptive Moment Estimation (Adam), Root Mean Square Propagation (RMSprop), Radial Base Function (RBF) and Limited-memory BFGS (L-BFGS). The type of optimizer 626 used may be determined based on the type of model structure 620 and the size of data and the computing resources available in the data layer 602.

The regularization engine 628 executes regularization operations. Regularization is a technique that prevents over-and under-fitting of the AI model 630. Overfitting occurs when the algorithm 616 is overly complex and too adapted to the training data, which can result in poor performance of the AI model 630. Underfitting occurs when the algorithm 616 is unable to recognize even basic patterns from the training data such that it cannot perform well on training data or on validation data. The regularization engine 628 can apply one or more regularization techniques to fit the algorithm 616 to the training data properly, which helps constraint the resulting AI model 630 and improves its ability for generalized application. Examples of regularization techniques include lasso (L1) regularization, ridge (L2) regularization, and elastic (L1 and L2 regularization).

The application layer 608 defines how the AI system 600 is used to solve problems or perform tasks. In an example implementation, the application layer 608 can implement logic that determines whether a predicted signal strength is sufficient for expected traffic in a beam cell and determines an amount of power boosting to apply. In an example implementation, the application layer 608 can be coupled with a transmission/antenna subsystem of the non-terrestrial satellite and is configured to switch or operate a power supply or circuitry of the subsystem. In some implementations, the application layer 608 is configured to generate a determination of whether power boosting should be performed for a given beam cell (and/or an amount of boosting to be performed) and to generate computer-readable commands or instructions for the antenna subsystem of the non-terrestrial satellite. Thus, the application layer 608 can be implemented to translate a predictive output of the AI model (e.g., quantitative RSRP predictions, binary classification of whether to activate boosting) to the desired outcome of a power boosted (or not) beam cell.

Returning to FIG. 4A, at 408, the system optionally and selectively configures reference signal power boosting for the beam cells based on the predicted signal strength information. In particular, if the predicted signal strength information satisfies a threshold (e.g., less than a threshold power such as −100 dBm), then reference signal power boosting can be configured such that the reference signals are more likely to be received by wireless devices with more signal strength than predicted/expected. In some example instances, the system may determine that the non-terrestrial satellite deploys the second set of beam cells with the reference signal power boosting during the fly-by. In other example instances, a subset of the second set of beam cells is selected for the reference signal power boosting. The subset may be selected based on cell-specific predictions of signal strength information. In some example instances, none of the second set of beam cells may be configured with reference signal power boosting if the predicted signal strength information does not satisfy the threshold (e.g., greater than −60 dBm). In some implementations, the beam cells may or may not be configured with reference signal power boosting based on onboard satellite resources, such as electrical power supply. In some implementations, a given beam cell may be configured with a particular amount of reference signal power boosting, such as an amount up to 1 dBm, up to 2 dBm, up to 6 dBm, up to 10 dBm, or up to 20 dBm. The particular amount can be determined based on a magnitude of difference between the predicted signal strength information and the threshold, and/or other factors such as satellite position relative to the geographic area, onboard satellite resources, traffic volume, and/or the like.

Example methods disclosed herein may be implemented (at least partially) remote from the non-terrestrial satellite that is scheduled or expected to deploy beam cells within the geographic area. For example, a central station (e.g., a ground system, one or more “central” satellites, and/or the like) may perform example operations disclosed herein to determine, for a particular satellite (e.g., a satellite identified at 404), a configuration of reference signal power boosting for the particular satellite's beam cells. In some implementations, such a central station may control a plurality of satellites (e.g., a constellation or a subset thereof), and the central station may be configured to determine the reference signal boosting configuration for each of the plurality of satellites. The central station may periodically (e.g., less than a minute granularity, less than a fifteen minute granularity, less than an hour granularity) predict the signal strength information for each satellite and its respective geographic area that it is approaching, and accordingly distribute signal boost configurations to the satellites. Such a mass prediction and configuration via a central station can reduce an amount of individual queries and tasks being performed by a pre-trained machine learning model configured to generate the predictions of signal strength information. For example, the machine learning model can be configured to output signal boost configurations (e.g., whether or not to perform boosting, which beam cells to boost) for multiple satellites and respective geographic areas given an input set of data for the multiple satellites and respective geographic areas. In such model configurations, relationships and interactions between adjacent geographic areas and nearby satellites can also be observed, learned, and used in inference by the model.

FIG. 5B is a flow diagram of a method for predictive boosting of downlink reference signals transmitted from non-terrestrial satellites. The method includes example operations that can be performed by a computing system, for example by at least one processor thereof executing instructions stored in at least one memory of the computing system. In some implementations, the computing system is an onboard system of a non-terrestrial satellite.

At 512, the non-terrestrial system reports, to a remote system, signal strength information collected from wireless devices in a first geographic area. The remote system may be implemented onboard another non-terrestrial satellite and/or be implemented at a terrestrial-based system. The signal strength information may be measured from downlink reference signals transmitted by the non-terrestrial system for beam cells it deployed in the first geographic area.

At 514, the non-terrestrial system obtains signal strength predictions for a second geographic area that are determined based on prior signal strength information associated with the second geographic area. In some implementations, the non-terrestrial system obtains the signal strength predictions based on locally determining the signal strength predictions. For example, the non-terrestrial system may implement a prediction model configured or pre-trained to generate the signal strength predictions using the prior signal strength information associated with the second geographic area. In some implementations, the non-terrestrial system obtains the signal strength predictions based on receiving the signal strength predictions from the remote system.

At 516, the non-terrestrial system deploys beam cells in the second geographic area, with a subset of which being configured with reference signal power boosting according to the signal strength predictions. For example, if the signal strength predictions suggest that wireless devices within the second geographic area will measure the signal strength of downlink reference signals from the non-terrestrial system at less than a threshold, then the non-terrestrial system may use reference signal power boosting. Based on the non-terrestrial system obtaining signal strength predictions prior to the deployment of beam cells in the second geographic area, the non-terrestrial system can perform various resource conservation or re-distribution operations onboard the non-terrestrial system to enable the power boosting to be performed. For example, the non-terrestrial system may divert electrical power from relatively non-critical subsystems (e.g., onboard lighting subsystems, environmental monitoring subsystems, redundancy subsystems, and/or the like) to an antenna or transmission subsystem in preparation for the reference signal power boosting. In a further example, the non-terrestrial system determines an increased number of antennas or antenna panels to use for deploying a beam cell with increased reference signal power.

Example techniques disclosed herein may be implemented (at least partially) locally onboard a non-terrestrial satellite that is scheduled or expected to deploy beam cells within a given geographic area. For example, an individual satellite can predict whether it needs to perform reference signal boosting for an upcoming fly-by based on locally determining predictions of signal strength information for the upcoming fly-by. In some examples, the individual satellite can query a prediction model that is implemented remotely in order to obtain the predictions of signal strength information. As such, within a large constellation of satellites, individual satellites may be querying the prediction model at different times, based on their respective speeds/trajectories and the timing of their fly-bys.

The solutions disclosed herein for reference signal boosting by a satellite for an upcoming fly-by can be performed in combination with other solutions in the present document. For example, a satellite may preemptively determine that it will boost reference signals for an upcoming fly-by, based on information or predicted likelihood that the wireless devices in the beam deployment area are able to dynamically configure their power classes. As a further example, a satellite may boost downlink reference signals for certain beams depending on the bandwidth allocation (e.g., only full spectrum beams are provided with reference signal boosting, only beams with reduced bandwidth and spectrum hopping are provided with reference signal boosting).

### Example Techniques for Intelligent Bandwidth Use in Non-terrestrial Networks

As discussed above, technical challenges related to connectivity between ground stations and non-terrestrial satellites, and operation of non-terrestrial systems generally, can be addressed (in addition or alternative to other solutions disclosed herein) through managing spectrum allocation in non-terrestrial networks. In particular, solutions disclosed herein provide for allocating different (and dynamic) bandwidths to different beam cells depending on predicted traffic loads.

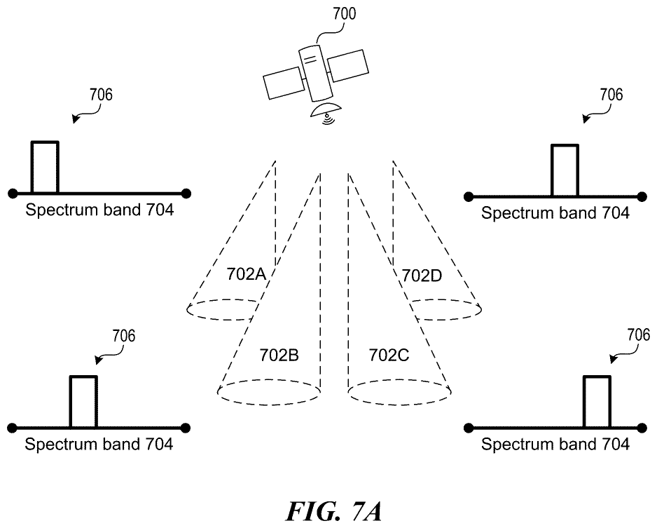

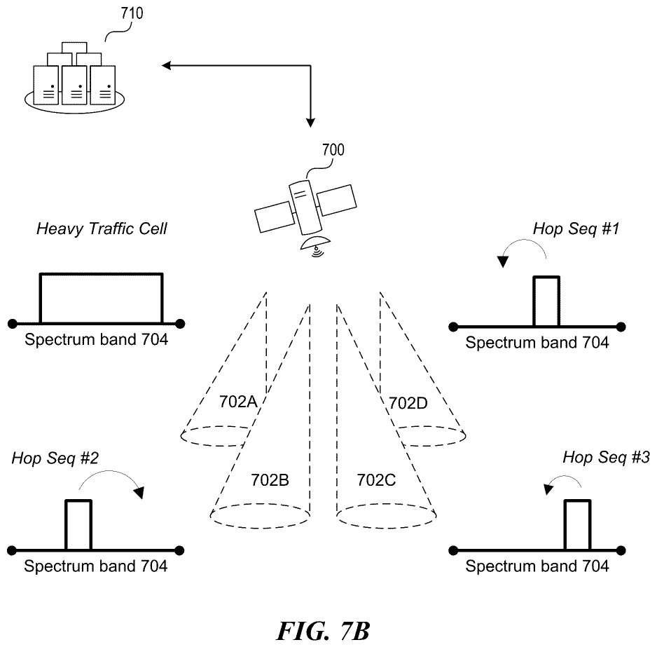

FIGS. 7A and 7B illustrate example bandwidth reservation/allocation techniques for satellite beam cells of a non-terrestrial network. According to example implementations, bandwidth reservation/allocation techniques can be used to minimize interference between different network cells. In particular, disclosed bandwidth reservation/allocation techniques (e.g., spectrum re-use techniques) can be used when one satellite or non-terrestrial node of a non-terrestrial network is projecting or deploying multiple beams (e.g., pencil beams) to form multiple network cells in a geographic area.

In the illustrative non-limiting example shown in FIG. 7A, a non-terrestrial satellite 700 is expected to project or deploy four beam cells 702A-702D in a geographic area. The beam cells 702A-702D may be located throughout the geographic area, and the beam cells 702A-702D may be located adjacent to or nearby one another, due at least in part to originating from the same source, the non-terrestrial satellite 700. The non-terrestrial satellite 700 can be configured to provide the beam cells 702A-702D for a duration that it passes over or by the geographic area.

According to example implementations, the non-terrestrial satellite 700 can be a component of a telecommunications network, and accordingly can be configured for communications in a particular spectrum band (e.g., a licensed band, the Personal Communications Service (PCS) band, the Advanced Wireless Services (AWS) band). In contrast to terrestrial networks in which the cells are relatively sparse, the beam cells 702A-702D are relatively smaller and more closely packed. As such, use of the full spectrum band in each of the beam cells 702A-702D will likely result in radio interference among the beam cells 702A-702D.

Therefore, according to the example technique shown in FIG. 7A, each beam cell is assigned with a different portion of the spectrum band 704, or a partial spectrum bandwidth 706. In an example, the network may operate on a 5 MHz band, and in the group of four beam cells 702A-702D, a first beam cell 702A is assigned with a first partial spectrum bandwidth 706A that is 1.5 MHz (e.g., a bandwidth part (BWP)), a second beam cell 702B is assigned with a second 1.5 MHz portion, and so on. As demonstrated in FIG. 7A, none of the 1.5 MHz portions overlap with one another.

In various examples, the partial spectrum bandwidths 706 assigned to each of the beam cells is uniform and can depend on the number of beam cells (e.g., 1.5 MHz for four beam cells), interference behavior/characteristics, location and/or packing configuration of the beam cells, and/or the like. Further, in the example technique shown in FIG. 7A, the partial spectrum bandwidths 706 may be static.

In the example technique shown in FIG. 7A, however, the range and/or quality of telecommunications services provided in each beam cell is limited due to each beam cell's inability to take advantage of the entirety of the spectrum band 704. For example, user equipment (UE) is each of the beam cells 702A-702D might only reliably use Short Message Service (SMS) services and/or other non-real-time services.

FIG. 7B shows another example technique for bandwidth reservation/allocation and spectrum re-use with beam cells provided by a non-terrestrial satellite 700. The example implementation demonstrated in FIG. 7B can avoid limitations on the available telecommunications services in the beam cells and intelligently adapts to traffic loads in the beam cells in order to optimize spectrum resources.

In the illustrative non-limiting example shown in FIG. 7B, the non-terrestrial satellite 700 is again expected to provide four beam cells 702A-702D in a geographic area. At least one of the four beam cells 702A-702D is assigned with a larger spectrum bandwidth, (e.g., the entirety of the spectrum band 704) while the remaining ones of the four beam cells 702A-702D are assigned with a different spectrum bandwidth. In example implementations, the spectrum bandwidth assigned to the remaining beam cells may be smaller bandwidths. In an example implementation, the remaining beam cells (702B-702D) may be assigned with bandwidth in a different band than the one beam cell, which may be equal-sized, larger, or smaller than the bandwidth assigned to the one beam cell. Due at least in part to the larger spectrum bandwidth being assigned to a particular beam cell (e.g., first beam cell 702A), the smaller spectrum bandwidths assigned to the remaining beam cells may overlap with the larger spectrum bandwidth, while remaining non-overlapping with one another, in some implementations. To minimize interference with the larger spectrum bandwidth (e.g., the full spectrum band), the smaller spectrum bandwidths assigned to the remaining beam cells can be configured to hop or dynamically change to different portions of the spectrum band over time.

Particularly, in FIG. 7B's illustrative non-limiting example, a first beam cell 702A is assigned with the full 5 MHz of the spectrum band 704, while each of the second beam cell 702B, third beam cell 702C, and fourth beam cell 702D are configured to only use 1.5 MHz of the spectrum band 704. The 1.5 MHz used by each of the second beam cell 702B, third beam cell 702C, and fourth beam cell 702D are non-overlapping with one another.

Furthermore, the 1.5 MHz used by each of the second beam cell 702B, third beam cell 702C, and fourth beam cell 702D dynamically changes according to a hop sequence generated for each beam cell. A 5 MHz spectrum band includes four 1.5 MHz portions. Accordingly, a hop sequence generated for a beam cell may specify that the beam cell uses the first 1.5 MHz portion, then the third 1.5 MHz portion, then the fourth 1.5 MHz portion, and then the second 1.5 MHz portion (i.e., the sequence being [1, 3, 4, 2]), with the sequence repeating over the duration that the beam cell is deployed.

In some implementations, the hop sequences are randomly generated for each beam cell being configured with the smaller spectrum bandwidth. The hop sequences for adjacent or nearby beam cells do not intersect, or result in the adjacent or nearby beam cells using the same portions of the spectrum band. For example, two neighboring beam cells would not have the respective sequences of [1, 3, 4, 2] and [3, 2, 4, 1], which would result in both beam cells using the fourth 1.5 MHz portion at the third time unit in the sequence.

In some implementations, the beam cells follow a universal hop sequence and are assigned with a different starting point within the universal hop sequence. In an example, the hop sequence is [1, 2, 3, 4], and the second beam cell 702B starts at the first sequence position (i.e., the first 1.5 MHz portion), the third beam cell 702C starts at the second sequence position, and the fourth beam cell 702D starts at the fourth sequence position.

The assignment of either the larger or smaller spectrum bandwidth to a given beam cell is based upon the expected traffic load in the beam cell. Beam cells expected to have heavy traffic can be assigned with the larger spectrum bandwidth (e.g., a full 5 MHz band, and the remaining beam cells expected to have relatively lighter traffic are assigned with the smaller and hopping spectrum bandwidths. The expected traffic loads are predicted before the beam cells are deployed by the non-terrestrial satellite 700 in the geographic area and are based on historical network traffic information for the geographic area.

In particular, example implementations can predict the expected traffic loads for the beam cells using a trained prediction model. The prediction model can be trained and/or configured according to the historical network traffic information and can be used to predict the expected traffic loads for the planned deployment time, or flyby time of the satellite over or by the geographic area. For example, the model's training can capture patterns in the historical network traffic information that may suggest higher network traffic for the geographic area (or portions thereof) during weekdays, or in the afternoon of each day. Based on the scope of historical network traffic information provided to the prediction model for training (e.g., information spanning multiple months for the geographic area compared to information spanning a week), the prediction model can incorporate short-term and/or long-term patterns of network traffic into its prediction of the expected traffic loads for the upcoming deployment of beam cells by the non-terrestrial satellite approaching the geographic area. In some implementations, the prediction model can be implemented via the AI system 600 described with FIG. 6.

According to some implementations, the prediction model is trained on the historical data via deep learning techniques. In such implementations, the prediction model is an artificial neural network model (e.g., a convolutional neural network (CNN), a recurrent neural network (RNN), and/or the like) that can be trained to minimize losses against the historical traffic load information. The loss minimization trained into the prediction model can involve adjusting parameters through multiple layers of the prediction model. Other implementations of the prediction model can include regression models, statistical models, and/or the like.

In some implementations, the prediction model is implemented by a ground station 710, or a computing system remote from the satellite 700 and that can be terrestrially based. For example, the ground station 710 is a ground control station operating or communicating with a plurality of non-terrestrial satellites. In some examples, the ground station 710 can include or be communicably coupled with a cloud computing platform, a distributed computing platform, and/or the like.

The ground station 710 can perform training tasks for the prediction model, as well as the inferences that predict the expected traffic loads for the beam cells. Accordingly, in some examples, the ground station 710 can transmit the predicted traffic loads to the non-terrestrial satellite 700, based on which the non-terrestrial satellite 700 can configure its beam cells based on the predicted traffic loads according to the techniques disclosed herein. In other examples, the ground station 710 can determine and transmit the bandwidth configurations for the beam cells to the non-terrestrial satellite 700, whereupon the non-terrestrial satellite 700 can implement or execute the (terrestrially determined) bandwidth configurations.

In some implementations, the ground station 710 further stores the historical network traffic information used to train and/or configure the prediction model. The historical network traffic information can be continuously updated to include new network traffic information collected for each flyby of satellites over/by the geographic area. With the continuous update or addition to the historical network traffic information, the prediction model can be retrained. For example, after the beam cells are provided or deployed within the geographic area by the non-terrestrial satellite 700, the non-terrestrial satellite 700 can record or collect actual traffic load data and contribute that data to the re-training of the prediction model.

In some implementations, the prediction model is implemented by a plurality of non-terrestrial satellites 700. For example, the non-terrestrial satellites 700 can be configured according to an Open RAN architecture or a similar architecture in which computing/processing tasks can be distributed among multiple of the non-terrestrial satellites 700. In a particular example of such an architecture, non-terrestrial satellites 700 having a similar or same trajectory, route, or orbit that passes over/by the same geographic area can contribute to storing historical network traffic information for that geographic area and training a prediction model for predicting traffic loads in that geographic area. Generally, various operations disclosed herein can be distributed among various central units (CUs) and/or distributed units (DUs) or similar roles assigned among a group of non-terrestrial satellites 700.

In the illustrated example of FIG. 7B, only the first beam cell is assigned with the larger spectrum bandwidth (e.g., a full 5 MHz), and the demonstrated examples involved quarter portions (1.5 MHz) of the spectrum band. Certain implementations of non-terrestrial satellites 700 can be configured to deploy significantly high beam counts, such as 256 to 512 beams per satellite. In some implementations, the high load cells are first identified, and if sparse enough, the larger spectrum bandwidth is assigned for those high load cells, while the remaining cells between/among those high load cells are assigned with the smaller and hopping spectrum bandwidths. Furthermore, the presence of terrestrial cells within the geographic area can contribute to the assignment of either the larger spectrum bandwidth or the smaller hopping spectrum bandwidth to each beam cell. For example, even given a prediction of a high traffic load, a particular beam cell can be configured with the smaller hopping spectrum bandwidth due at least to a larger or full spectrum use being likely to interfere with nearby terrestrial cells in the geographic area.

Thus, the configuration of either the larger spectrum bandwidth (e.g., a full 5 MHz bandwidth) or the smaller hopping spectrum bandwidth (e.g., a partial 1.5 MHz bandwidth) can be based on the geographic layout of the beam cells within the geographic area, in addition to the predicted traffic load. In some implementations, a threshold inter-cell proximity or distance can be determined based on interference characteristics or behavior in the geographic area, based on expected or desired service quality and/or service types in the geographic area, and/or the like. Groups or subsets of beam cells that are less than the threshold inter-cell proximity from one another can be identified, and the spectrum re-use solutions disclosed herein can be performed for each group of beam cells. For example, in each group or subset of beam cells, one or more beam cells with the highest predicted traffic load are assigned with the larger spectrum bandwidth and the remaining beam cells are assigned with the smaller hopping spectrum bandwidth.

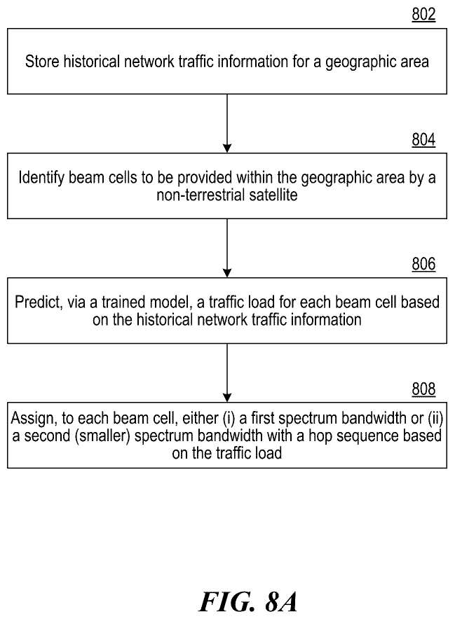

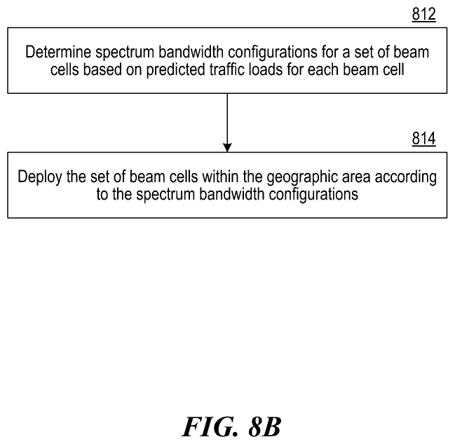

FIG. 8A is a flow diagram of a method for intelligently assigning spectrum bandwidth to satellite beam cells of a non-terrestrial network. The method includes example operations that can be performed by a computing system, for example by at least one processor thereof executing instructions stored in at least one memory of the computing system. In some implementations, the computing system is a ground-based system, such as a ground control station (GCS) for one or more non-terrestrial satellites. In some implementations, the computing system is a non-terrestrial system, such as one particular satellite or a group of satellites sharing computing/processing and storage functions.

At 802, the system stores historical network traffic information for a geographic area. The historical network traffic information describes the volume of network traffic (e.g., a total number or rate of random access channel (RACH) requests), the number of user equipment (UE), and/or the like experienced in the geographic area at a certain historical time. In some examples, the historical network traffic information can include data collected by satellites deploying prior beam cells in the geographic area. In some examples, the historical network traffic information includes data collected by terrestrial cells deployed in the geographic area, or generally data collected from terrestrial sources.

At 804, the system identifies beam cells to be provided within the geographic area by a non-terrestrial satellite. In some implementations, the system identifies a subset of the beam cells that are planned for the non-terrestrial satellite to deploy that are grouped or located in proximity, based on satisfying a threshold inter-cell distance from one another (e.g., being less than the threshold inter-cell distance from one another). This identification particularly focuses on the potential for interference problems to occur. The identification of certain beam cells that may interfere with one another then allows the system to intelligently allocate bandwidth among those beam cells.

At 806, the system predicts, via a trained model, a traffic load for each beam cell based on the historical network traffic information. In some implementations, the trained model is an artificial neural network model, a regression model, and/or the like. In some implementations, the prediction is relative among a subset or group of beam cells; for example, the system predicts which beam cells will have the highest traffic loads compared to the other beam cells. In some implementations, the prediction is a traffic load value comparable against a threshold load, or the prediction is a classification of heavy or light traffic load relative to a threshold learned from the historical data.

At 808, the system assigns a bandwidth configuration to each beam cell based on the predicted traffic load for each beam cell. The bandwidth configuration for a given beam cell can be a first spectrum bandwidth or a second spectrum bandwidth that is different (e.g., smaller) than the first spectrum bandwidth. Beam cells having a heavy predicted traffic load can be assigned with the first spectrum bandwidth, so that those cells can take advantage of a larger amount of spectrum band resources. The remaining beam cells having lighter predicted traffic load can thus be assigned with the second spectrum bandwidth. The second spectrum bandwidth can overlap with or be a portion of the first spectrum bandwidth, and the second/smaller spectrum bandwidth assigned to different beam cells can be non-overlapping with one another. The second spectrum bandwidth can be configured to dynamically change to different preset/predefined frequencies over time according to a hop sequence.

Accordingly, the system can reduce interference occurring among satellite beam cells and improve telecommunications service based on assigning different spectrum bandwidths to different beam cells, with some spectrum bandwidths being maximized based on predicted traffic load and other spectrum bandwidths being dynamic to avoid interference.

FIG. 8B is a flow diagram of a method for intelligently assigning spectrum bandwidth to satellite beam cells of a non-terrestrial network. The method includes example operations that can be performed by a computing system, for example by at least one processor thereof executing instructions stored in at least one memory of the computing system. In some implementations, the computing system is an onboard system of a non-terrestrial satellite.

At 812, the non-terrestrial system determines spectrum bandwidth configurations for a set of beam cells based on predicted traffic loads for each beam cell. In some implementations, the non-terrestrial system receives the predicted traffic loads from a terrestrial system, thereby preserving computing/processing resources onboard the non-terrestrial system from resource-intensive tasks related to the prediction of traffic loads (e.g., inference tasks with a machine learning model). In some implementations, the non-terrestrial system receives the spectrum bandwidth configurations, which are determined by the terrestrial system. In some implementations, the non-terrestrial system determines the spectrum bandwidth configurations prior to and based on the non-terrestrial satellite approaching the geographic area. The bandwidth configurations for a given beam cell can define an amount or portion of a spectrum band used by the network and can indicate whether or not (and/or how) the bandwidth used by the given beam cell hops to different frequencies.

At 814, the non-terrestrial system deploys the set of beam cells within the geographic area according to the spectrum bandwidth configurations. The non-terrestrial system can deploy the set of beam cells for a duration that the non-terrestrial satellite passes over/by the geographic area. In some implementations, the non-terrestrial system is configured to deploy the set of beam cells while the non-terrestrial satellite has line-of-sight with the geographic area, and the duration is less than or equal to the time that the non-terrestrial satellite has line-of-sight with the geographic area.

Following deployment of the set of beam cells, the non-terrestrial system can communicate, to a ground/remote/terrestrial system and/or one or more other non-terrestrial system, actual traffic loads that it encountered during the deployment of the set of beam cells. The communication of actual traffic loads enables refinement and retraining of the prediction of traffic loads for the geographic loads, improving the accuracy and efficiency of spectrum bandwidth configurations for later beam cells deployed within the geographic area.

The solutions disclosed herein for reference signal boosting by a satellite for an upcoming fly-by can be performed in combination with other solutions in the present document. For example, the prediction of traffic load for each beam cell can incorporate information regarding whether the wireless devices expected to be served by each beam cell are configured for dynamic power class selection.

### Example Computing Systems

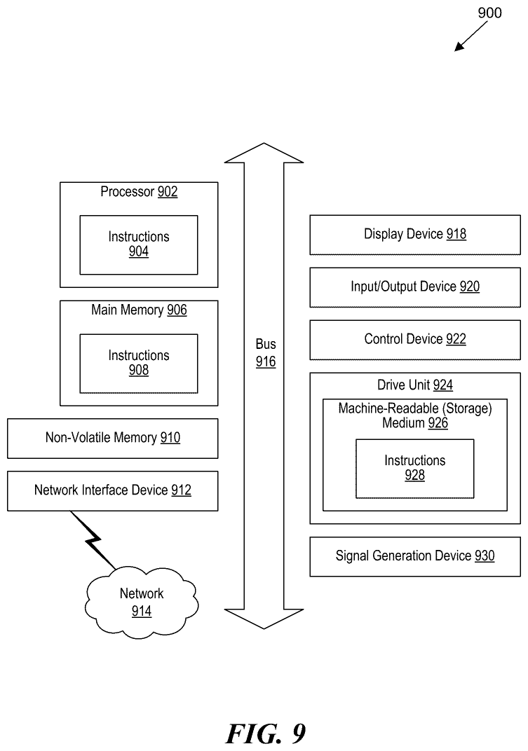

FIG. 9 is a block diagram that illustrates an example of a computing system 900 in which at least some operations described herein can be implemented. As shown, the computing system 900 can include: one or more processors 902, main memory 906, non-volatile memory 910, a network interface device 912, a video display device 918, an input/output device 920, a control device 922 (e.g., keyboard and pointing device), a drive unit 924 that includes a machine-readable (storage) medium 926, and a signal generation device 930 that are communicatively connected to a bus 916. The bus 916 represents one or more physical buses and/or point-to-point connections that are connected by appropriate bridges, adapters, or controllers. Various common components (e.g., cache memory) are omitted from FIG. 9 for brevity. Instead, the computing system 900 is intended to illustrate a hardware device on which components illustrated or described relative to the examples of the figures and any other components described in this specification can be implemented.

In some implementations, the signal generation unit 924 and/or the network interface device 912 comprises one or more antennae for wirelessly transmitting and receiving signals with other systems. The antennae of the signal generation unit 924 and/or the network interface device 912 may be coupled to a battery unit of the computing system 900, which supplies power for electrically exciting the antennae. The signal generation unit 924 and/or the network interface device 912 may be configured to operate the antennae according to one of a plurality of power classes, based on which a transmit power of the antennae is controlled/limited.

The computing system 900 can take any suitable physical form. For example, the computing system 900 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 900. In some implementations, the computing system 900 can be an embedded computing system, a system-on-chip (SOC), a single-board computing system (SBC), or a distributed system such as a mesh of computing systems, or it can include one or more cloud components in one or more networks. Where appropriate, one or more computing systems 900 can perform operations in real time, in near real time, or in batch mode.

The network interface device 912 enables the computing system 900 to mediate data in a network 914 with an entity that is external to the computing system 900 through any communication protocol supported by the computing system 900 and the external entity. Examples of the network interface device 912 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 906, non-volatile memory 910, machine-readable medium 926) can be local, remote, or distributed. Although shown as a single medium, the machine-readable medium 926 can include multiple media (e.g., a centralized/distributed database and/or associated caches and servers) that store one or more sets of instructions 928. The machine-readable medium 926 can include any medium that is capable of storing, encoding, or carrying a set of instructions for execution by the computing system 900. The machine-readable medium 926 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 910, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in computing device(s). When read and executed by the processor 902, the instruction(s) cause the computing system 900 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A method for non-terrestrial wireless network communication, comprising:
configuring, by a wireless device that is classified for a first power class, a terrestrial communication mode of the wireless device to use a second power class, the second power class having a second maximum transmit power that is less than a first maximum transmit power of the first power class;
in response to a disconnect condition experienced by the wireless device with a terrestrial wireless network while operating in the terrestrial communication mode, transitioning, by the wireless device, from the terrestrial communication mode to a non-terrestrial communication mode in which the wireless device connects to a non-terrestrial network comprising one or more non-terrestrial nodes, wherein the non-terrestrial communication mode is configured to initially continue using the second power class;
determining, by the wireless device, a connection success information while the wireless device is connected to the one or more non-terrestrial nodes of the non-terrestrial network; and
in response to the connection success information failing to satisfy a threshold, re-configuring, by the wireless device, the non-terrestrial communication mode of the wireless device to use the first power class for a duration.

2. The method of claim 1, wherein re-configuring the non-terrestrial communication mode of the wireless device to use the first power class comprises the wireless device reporting use of the first power class to the non-terrestrial network.

3. The method of claim 1, wherein the wireless device re-configures the non-terrestrial communication mode of the wireless device to use the first power class further in response to a radio frequency (RF) safety condition being satisfied.

4. The method of claim 3, wherein the RF safety condition comprises the wireless device being located at least a threshold distance away from a user's head based on at least one of (i) a type of user service being currently performed on the wireless device, (ii) sensor data generated by the wireless device, or (iii) a device type of the wireless device being at least one of an Internet-of-Things (IoT) device or non-personal device.

5. The method of claim 1, wherein the connection success information comprises at least one of a random access channel (RACH) success rate, a higher layer service success rate including a short messaging service (SMS) or multimedia messaging service (MMS) delivery rate, or a non-access stratum (NAS) signaling success rate.

6. The method of claim 1, further comprising:
further re-configuring, by the wireless device, the non-terrestrial communication mode of the wireless device to return to the second power class subsequent to the duration, in response to at least one of a battery condition or an updated connection success information.

7. The method of claim 1, wherein the first power class is PC2 and the first maximum transmit power is 26 dBm, and wherein the second power class is PC3 with the second maximum transmit power being 23 dBm.

8. The method of claim 1, wherein the non-terrestrial network is configured for non-time-division-duplex (non-TDD) bidirectional communications.

9. The method of claim 1, wherein the disconnect condition experienced by the wireless device while operating in the terrestrial communication mode comprises receiving a public land mobile network (PLMN) identifier or a physical cell ID (PCI) that is associated with the non-terrestrial network.

10. A wireless device comprising:
at least one hardware processor; and
at least one memory storing instructions that, when executed by the at least one hardware processor, cause the wireless device to
use a second power class while operating in a terrestrial communication mode, the second power class having a second maximum transmit power that is less than a first maximum transmit power of the first power class, wherein the wireless device is capable of using the first power class;
in response to a transition from the terrestrial communication mode to a non-terrestrial communication mode, determine a connection success information for a connection between the wireless device and one or more non-terrestrial nodes of a non-terrestrial network; and
re-configuring the wireless device to use the first power class while connected to the one or more non-terrestrial nodes of the non-terrestrial network based on the connection success information.

11. The wireless device of claim 10, wherein re-configuring the wireless device to use the first power class comprises the reporting use of the first power class to the non-terrestrial network.

12. The wireless device of claim 10, wherein the wireless device is re-configured to use the first power class further in response to a radio frequency (RF) safety condition being satisfied, the RF safety condition comprising the wireless device being located at least a threshold distance away from a user's head.

13. The wireless device of claim 10, wherein the instructions further cause the wireless device to:
cause the transition from the terrestrial communication mode to the non-terrestrial communication mode in response to a disconnect condition experienced by the wireless device with a terrestrial network.

14. The wireless device of claim 10, wherein the connection success information comprises a random access channel (RACH) success rate.

15. The wireless device of claim 10, wherein the non-terrestrial network is configured for frequency-division-duplex (FDD) bidirectional communications.

16. At least one non-transitory computer-readable medium having executable instructions stored thereon, the executable instructions when executed by at least one processor of a wireless device cause the wireless device to perform a process comprising:
using a second power class while operating in a terrestrial communication mode, the second power class having a second maximum transmit power that is less than a first maximum transmit power of the first power class, wherein the wireless device is capable of using the first power class;
in response to a transition from the terrestrial communication mode to a non-terrestrial communication mode, determine a connection success information for a connection between the wireless device and one or more non-terrestrial nodes of a non-terrestrial network; and
re-configuring the wireless device to use the first power class while connected to the one or more non-terrestrial nodes of the non-terrestrial network based on the connection success information.

17. The at least one non-transitory computer-readable medium of claim 16, wherein re-configuring the wireless device to use the first power class comprises the reporting use of the first power class to the non-terrestrial network.

18. The at least one non-transitory computer-readable medium of claim 16, wherein the wireless device is re-configured to use the first power class further in response to a radio frequency (RF) safety condition being satisfied, the RF safety condition comprising the wireless device being located at least a threshold distance away from a user's head.

19. The at least one non-transitory computer-readable medium of claim 16, wherein the instructions further cause the wireless device to:
cause the transition from the terrestrial communication mode to the non-terrestrial communication mode in response to a disconnect condition experienced by the wireless device with a terrestrial network.

20. The at least one non-transitory computer-readable medium of claim 16, wherein the non-terrestrial network is configured for frequency-division-duplex (FDD) bidirectional communications.

21-60. (canceled)
